(19) United States
(12) Patent Application Publication
(10) Pub. No.: US 2025/0374406 A1
(43) Pub. Date: Dec. 4, 2025

(54) INTERIOR LIGHT CONTROL SYSTEM

(71) Applicant: SUBARU CORPORATION, Tokyo (JP)

(72) Inventors: Ryosaku KISHI, Tokyo (JP); Saya NISHIO, Tokyo (JP)

(73) Assignee: SUBARU CORPORATION, Tokyo (JP)

(21) Appl. No.: 19/217,837

(22) Filed: May 23, 2025

(30) Foreign Application Priority Data
Jun. 3, 2024 (JP) 2024-089922

(51) Int. Cl. H05B 47/16; B60Q 3/74; B60Q 3/80; H05B 47/105

(52) U.S. Cl. CPC H05B 47/16; B60Q 3/74; B60Q 3/80; H05B 47/105

(57) ABSTRACT

An interior light control system configured to be applied to a vehicle includes an interior light and a processor. The interior light is configured to light an interior of the vehicle. The processor is configured to control turning on and off of the interior light, based on opening and closing of a door of the vehicle. The processor is configured to: when the door is opened, turn on the interior light; when the door is closed, turn off the interior light after a first time period has elapsed; and, when the door is closed where the door is opened before a predetermined time period elapses after previous closing of the door with ignition of the vehicle being stopped, turn off the interior light after a second time period has elapsed. The second time period is shorter than the first time period.

### CROSS-REFERENCE TO RELATED APPLICATIONS

The present application claims priority from Japanese Patent Application No. 2024-089922 filed on Jun. 3, 2024, the entire contents of which are hereby incorporated by reference.

### BACKGROUND

The disclosure relates to an interior light control system to be applied to a vehicle.

Japanese Unexamined Patent Application Publication (JP-A) No. 2007-090984 discloses, as a technique that reduces power consumption of an in-vehicle battery, a technique that reduces a time period before an interior light of a vehicle is automatically turned off in controlling the interior light when a door of the vehicle is opened and closed after ignition is switched from ON to OFF.

The technique of JP-A No. 2007-090984 controls to shorten the time period before the interior light is turned off after the door is closed when the door is opened and closed for a first time after the ignition is switched OFF, and not to shorten the time period before the interior light is turned off after the door is closed when the door is thereafter opened and closed for a second time after the ignition is switched OFF.

When the door is opened and closed after a driver who drives the vehicle finishes driving the vehicle and switches OFF the ignition, it is predicted that the driver exits the vehicle. Performing the control described above makes it possible to reduce the power consumption of the in-vehicle battery by shortening a lighting time period of the interior light after the door is closed when it is predicted that the driver exits the vehicle. When the door is thereafter opened and closed at a point in time other than after switching OFF the ignition, it is predicted that a driver enters the vehicle. It is possible to provide supplementary lighting for the driver when the driver enters the vehicle by refraining from shortening the lighting time period of the interior light after the door is closed when it is predicted that the driver enters the vehicle.

### SUMMARY

An aspect of the disclosure provides an interior light control system configured to be applied to a vehicle. The interior light control system includes an interior light and a processor. The interior light is configured to light an interior of the vehicle. The processor is configured to control turning on and off of the interior light, based on opening and closing of a door of the vehicle. The processor is configured to: when the door is opened, turn on the interior light; when the door is closed, turn off the interior light after a first time period has elapsed; and, when the door is closed where the door is opened before a predetermined time period elapses after previous closing of the door with ignition of the vehicle being stopped, turn off the interior light after a second time period has elapsed. The second time period is shorter than the first time period.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of an interior light control system according to one example embodiment of the disclosure.

FIG. 2 is a flowchart illustrating a control flow of a lighting ECU of the interior light control system illustrated in FIG. 1.

FIG. 3 is a flowchart illustrating a control flow of a lighting ECU according to a modification example of the interior light control system illustrated in FIG. 1.

### DETAILED DESCRIPTION

In an existing technique such as that disclosed in JP-A No. 2007-090984, when a door is opened and closed for a first time after ignition is switched OFF, it is predicted that the door is opened and closed to exit a vehicle, and a lighting time period of an interior light is therefore shortened. When the door is opened and closed for a second time after the ignition is switched OFF, it is predicted that the door is opened and closed to enter the vehicle, and the lighting time period of the interior light is therefore not shortened. Such a control is performed to achieve a balance between reducing power consumption of a battery and ensuring visibility in the vehicle interior for driving preparation.

However, there may be cases where, after the ignition is switched OFF, the door is opened and closed multiple times in a short time for a purpose other than for entering the vehicle, such as a case of working adjacent the vehicle or camping. In the existing technique, it is difficult to reduce the power consumption of the battery in such cases.

It is desirable to provide an interior light control system to be applied to a vehicle that makes it possible to reduce power consumption of a battery due to lighting of an interior light, in a case where there is a high possibility that a door is opened and closed for a reason other than for entering the vehicle, such as a case where the door is opened and closed multiple times in a short time.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

An interior light control system 1 according to an example embodiment may include a plurality of devices to be controlled (hereinafter, simply referred to as a plurality of control target devices) mounted on a vehicle 2 and a plurality of electronic control units (ECUs). Each of the ECUs may serve as a processor of the respective control target device. The control target devices and the ECUs may be communicably coupled to each other by an in-vehicle network 4, such as a controller area network (CAN) or a local interconnect network (LIN), and a central gateway (CGW) 3. The central gateway (CGW) 3 may serve as a relay device.

In the interior light control system 1, each of the ECUs may output, to the in-vehicle network 4, data indicating an operation state of the control target device to be controlled by each of the ECUs. Further, each of the ECUs may control an operation of the corresponding control target device, based on the data from other ECU acquired through the in-vehicle network 4.

Each of the ECUs may include, for example but not limited to, a processor such as a central processing unit (CPU) or a micro processing unit (MPU). The processor may execute various kinds of processes. Each of the ECUs may include a volatile storage device such as a random access memory (RAM) and a nonvolatile storage device such as a read only memory (ROM). The RAM may temporarily process data to be used by the processor. The ROM may store, for example but not limited to, programs to be executed by the processor and other components. In some embodiments, all or a part of operation to be executed by one or more of the ECUs may be implemented by hardware such as an application specific integrated circuit (ASIC), a field-programmable gate array (FPGA), or a graphics processing unit (GPU).

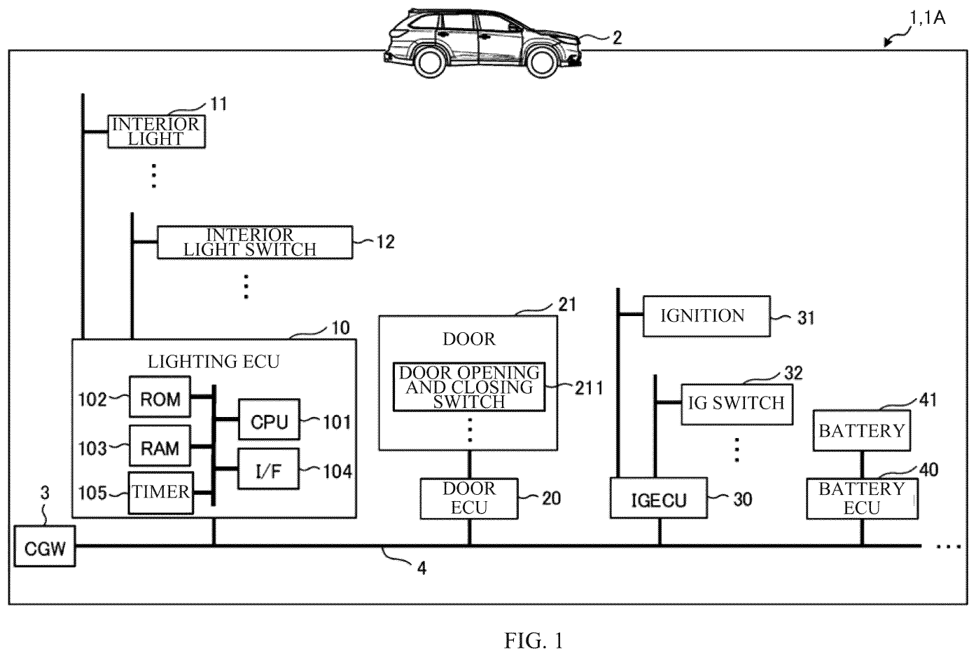

With reference to FIG. 1, the ECUs, the control target devices, and other components included in the interior light control system 1 according to the example embodiment will be described.

FIG. 1 illustrates a lighting ECU 10, a door ECU 20, an IGECU 30, and a battery ECU 40 out of the plurality of ECUs, and illustration of other ECU is omitted. Furthermore, FIG. 1 illustrates an interior light 11, a door 21, an ignition (IG) 31, and a battery 41 out of the plurality of control target devices, and illustration of other control target device, sensor, and other component is omitted. In the example embodiment, detailed description and illustration of an ECU and a control target device that do not participate in an operation performed by the interior light control system 1 are omitted even if these components are included in the interior light control system 1.

As illustrated in FIG. 1, the lighting ECU 10 may include a CPU 101, a ROM 102, a RAM 103, an I/F 104, and a timer 105. The lighting ECU 10 may control, for example, the interior light 11 by executing various kinds of processes, based on programs stored in the ROM 102 by the CPU 101. The ROM 102 provided as the nonvolatile storage device may hold programs that control, for example, the interior light 11, based on data from other ECUs acquired through the in-vehicle network 4 and input of, for example, an interior light switch 12 to be described later, and may hold various kinds of data to be used to execute the programs. In one embodiment, the CPU 101 may serve as a “processor”.

The RAM 103 provided as the volatile storage device may be used as a work area when the CPU 101 executes various kinds of processes. Various kinds of data outputted from, for example, each of the ECUs may therefore be temporarily stored in the RAM 103 as necessary.

The I/F 104 may control input and output of various kinds of data and control signals to be used in the lighting ECU 10. For example, the I/F 104 may receive data outputted from each of the ECUs to the in-vehicle network 4 and data outputted from, for example, the interior light switch 12 to be described later. Additionally, the I/F 104 may output a control signal generated in the CPU 101 to an output destination corresponding to control contents.

The CPU 101 may read the program stored in the ROM 102 into a memory such as the RAM 103 and execute the program, thereby performing a control of the interior light 11 in the interior light control system 1.

The timer 105 provided in the lighting ECU 10 may be used to measure, for example but not limited to, a lighting time period of the interior light 11 and a time period from when the door 21 is closed to when the door 21 is opened. A description will be given in detail later.

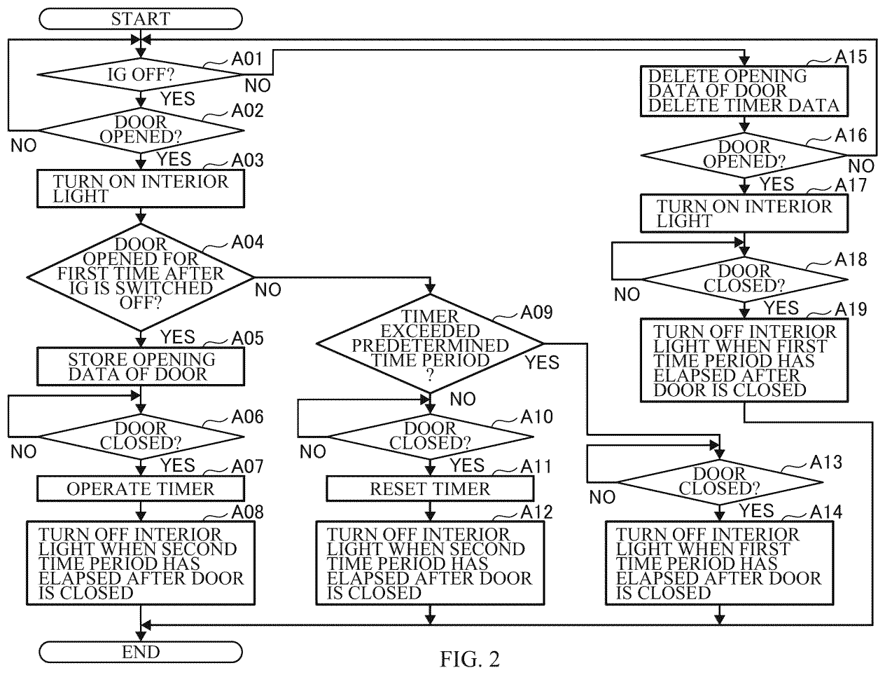

The interior light 11 may include a lighting device that is provided in the interior of the vehicle 2 and light the interior of the vehicle 2. Turning on and off the interior light 11 may be controlled by the lighting ECU 10. The control of the interior light 11 in the interior light control system 1 will be described in detail later with reference to FIG. 2.

The interior light switch 12 may include a switch that switches a lighting mode of the interior light 11. The interior light switch 12 may be switchable by a user between three states including an “AUTO (DOOR)” state, an “ON” state, and an “OFF” state. The interior light switch 12 may output a signal to the lighting ECU 10, based on a switching state of the interior light switch 12. The lighting ECU 10 may control the lighting mode of the interior light 11, based on the signal received from the interior light switch 12.

When the interior light switch 12 is in the “AUTO (DOOR)” state, the interior light 11 may be turned on and off in conjunction with the opening and closing of the door 21. For example, the interior light 11 is turned on when the door 21 is opened and is turned off when a first time period or a second time period has elapsed after the door 21 is closed. The first time period and the second time period will be described later with reference to FIG. 2.

When the interior light switch 12 is in the “ON” state, the interior light 11 may be turned on. When the interior light switch 12 is in the “ON” state, the interior light 11 may be kept on regardless of whether the door 21 is opened or closed unlike when the interior light switch 12 is in the “AUTO (DOOR)” state.

When the interior light switch 12 is in the “OFF” state, the interior light 11 may be turned off. When the interior light switch 12 is in the “OFF” state, the interior light 11 may be kept off regardless of whether the door 21 is opened or closed unlike when the interior light switch 12 is in the “AUTO (DOOR)” state.

The door ECU 20 may control each of the doors 21 of the vehicle 2 independently. For example, each of the doors 21 may be provided with a non-illustrated door lock mechanism that unlocks and locks the door 21 and a non-illustrated actuator used to open and close the door 21. The door ECU 20 may control the door lock mechanism and the actuator to open, close, lock, and unlock the door 21.

The door 21 may include a door opening and closing switch 211 that detects opening and closing of the door 21. The door opening and closing switch 211 may be provided for each of the doors 21 of the vehicle 2. The door ECU 20 may detect opening and closing of the door 21 in accordance with a signal received from the door opening and closing switch 211, and output data regarding opening and closing of the door 21 to the in-vehicle network 4. When the interior light switch 12 is in the “AUTO (DOOR)” state, the lighting ECU 10 may control turning on and off of the interior light 11, based on the data regarding opening and closing of the door 21 received from the door ECU 20 via the in-vehicle network 4.

Further, the lighting ECU 10 may operate the timer 105, based on the data regarding opening and closing of the door 21 received from the door ECU 20 via the in-vehicle network 4, and measure, for example but not limited to, the lighting time period of the interior light 11 and the time period from when the door 21 is closed to when the door 21 is opened. The lighting ECU 10 may control the interior light 11, based on measurement data of the timer 105. Details of the control will be described later.

The IGECU 30 may control the ignition 31. The ignition 31 may include a start-up device of the vehicle 2. When the ignition 31 is ON, components including, for example but not limited to, a non-illustrated drive system of the vehicle 2, a non-illustrated car information display (CID), and a non-illustrated air conditioner may be activated. The IGECU 30 may control switching ON and OFF of the ignition 31 in accordance with input to an IG switch 32 to be described later.

The IG switch 32 may include a switch that transmits to the IGECU 30 a signal that instructs switching of the ignition 31 between ON and OFF. The user of the vehicle 2 may operate the IG switch 32 to switch ON and OFF the ignition 31. When the user is to drive the vehicle 2, the user may operate the IG switch 32 to switch ON the ignition 31 and activate the non-illustrated drive system. In contrast, when the user is to finish driving of the vehicle 2, the user may operate the IG switch 32 to switch OFF the ignition 31 and stop the non-illustrated drive system.

The IGECU 30 may output to the in-vehicle network 4 data regarding switching of the ignition 31 between ON and OFF. The lighting ECU 10 may control switching on and off of the interior light 11, based on the data regarding switching of the ignition 31 between ON and OFF received from the IGECU 30 via the in-vehicle network 4. Details of the control will be described later.

The battery 41 may be controlled by the battery ECU 40. An in-vehicle electronic device mounted on the vehicle 2 including, for example but not limited to, the interior light 11 and the non-illustrated air conditioner, may be operated by consuming electric power supplied from the battery 41.

Next, a description is given of a control flow of the lighting ECU 10 in the interior light control system 1 according to the example embodiment with reference to FIG. 2. The control illustrated in FIG. 2 may be executed when the interior light switch 12 is in the “AUTO (DOOR)” state.

When the ignition 31 is in an OFF state (step A01: YES), the lighting ECU 10 may monitor opening of the door 21 (step A02). In a state where: the pieces of data regarding the door 21 and the ignition 31 have been acquired from the door ECU 20 and the IGECU 30 via the in-vehicle network 4; and the ignition 31 is in the OFF state (step A01: YES), upon detecting that the door 21 is opened (step A02: YES), the lighting ECU 10 may cause the interior light 11 to be turned on (step A03). When the ignition 31 is in an ON state (step A01: NO), the lighting ECU 10 may cause the process to proceed to step A15.

After the interior light 11 is turned on, the lighting ECU 10 may determine whether the door 21 is opened for a first time after the ignition 31 is switched OFF (step A04). When it is determined that the door 21 is opened for the first time after the ignition 31 is switched OFF (step A04: YES), the lighting ECU 10 may cause the process to proceed to step A05. When it is determined that the door 21 is opened for a second time or more after the ignition 31 is switched OFF (step A04: NO), the lighting ECU 10 may cause the process to proceed to step A09.

When it is determined that the door 21 is opened for the first time after the ignition 31 is switched OFF (step A04: YES), the lighting ECU 10 may store opening data of the door 21 (step A05). The opening data of the door 21 may be a part of the data regarding opening and closing of the door 21 outputted by the door ECU 20 to the in-vehicle network 4. It is possible to store the opening data of the door 21 by acquiring the data regarding opening and closing of the door 21. The determination of step A04 may be made based on whether the opening data of the door 21 is stored. For example, once the opening data of the door 21 is stored in the process of step A05, in step A04 that is executed when the door 21 is thereafter opened, the lighting ECU 10 may determine that the door 21 is opened for the second time or more after the ignition 31 is switched OFF (step A04: NO).

When the opening data of the door 21 is stored, the lighting ECU 10 may monitor closing of the door 21 (step A06). When detecting that the door 21 is closed based on data received from the door ECU 20 via the in-vehicle network 4 (step A06: YES), the lighting ECU 10 may operate the timer 105 (step A07).

Additionally, when detecting that the door 21 is closed (step A06: YES), the lighting ECU 10 may cause the interior light 11 to be turned off when the second time period has elapsed after detecting that the door 21 is closed (step A08) and end the series of processes. Step A07 and step A08 may be performed substantially at the same time. Here, the second time period may include, for example, a very short time period of about 1 to 2 seconds, or 0 seconds. When the second time period refers to 0 seconds, the interior light 11 may be turned off immediately after the door 21 is closed. It may be predicted that the opening and closing of the door 21 to be performed for the first time after the ignition 31 is switched OFF are carried out when an occupant exits the vehicle. For example, there may be a high possibility that turning on of the interior light 11 for driving preparation upon entering the vehicle is unnecessary. Accordingly, the lighting time period of the interior light 11 after the door 21 is closed may be shortened when the door 21 is opened and closed for the first time after the ignition 31 is switched OFF to reduce the power consumption of the battery 41.

When it is determined in step A04 that the door 21 is opened for the second time or more after the ignition 31 is switched OFF (step A04: NO), the lighting ECU 10 may determine whether the timer 105 exceeds a predetermined time period (step A09). Because the timer 105 is operated when the door 21 is opened and closed for the first time after the ignition 31 is switched OFF (step A07), when it is determined in step A04 that the door 21 is opened for the second time or more after the ignition 31 is switched OFF (step A04: NO), the measurement of the timer 105 may be ongoing. Here, the predetermined time period of the timer 105 may include, for example, 10 minutes. When it is determined that the timer 105 has not exceeded the predetermined time period (step A09: NO), the lighting ECU 10 may cause the process to proceed to step A10. When it is determined that the timer 105 has exceeded the predetermined time period (step A09: YES), the lighting ECU 10 may cause the process to proceed to step A13.

When it is determined that the timer 105 has not exceeded the predetermined time period when the door 21 is opened (step A09: NO), the lighting ECU 10 may monitor closing of the door 21 (step A10). When detecting that the door 21 is closed based on data received from the door ECU 20 via the in-vehicle network 4 (step A10: YES), the lighting ECU 10 may reset the measurement of the timer 105 (step A11). Additionally, when detecting that the door 21 is closed (step A10: YES), the lighting ECU 10 may cause the interior light 11 to be turned off when the second time period has elapsed after detecting that the door 21 is closed (step A12) and end the series of processes. Step A11 and step A12 may be performed substantially at the same time.

It may be predicted that the opening of the door 21 within the predetermined time period (for example, 10 minutes) from the previous closing of the door 21 has been made for a reason other than for entering the vehicle, such as a case of camping or working around the vehicle. For example, there may be a high possibility that turning on of the interior light 11 for driving preparation upon entering the vehicle is unnecessary. Accordingly, the lighting time period of the interior light 11 after the door 21 is closed may be shortened to reduce the power consumption of the battery 41. Furthermore, the measurement of the timer 105 may be reset when the door 21 is closed (step A11). This allows the lighting time period of the interior light 11 after the door 21 is closed to be shortened even in a case of opening and closing the door 21 repeatedly in a short time, which is highly likely to be for a reason other than for entering the vehicle. This makes it possible to reduce the power consumption of the battery 41.

In contrast, when it is determined that the timer 105 has exceeded the predetermined time period when the door 21 is opened (step A09: YES), the lighting ECU 10 may monitor closing of the door 21 (step A13). When detecting that the door 21 is closed based on the data received from the door ECU 20 via the in-vehicle network 4 (step A13: YES), the lighting ECU 10 may turn off the interior light 11 when the first time period has elapsed after the door 21 is closed (step A14) and end the series of processes. Here, the first time period may be longer than the second time period and may be a time period until the interior light 11 is turned off after the door 21 is closed. The first time period may be originally set in the vehicle 2. The first time period may include, for example, 15 seconds or 30 seconds.

It may be predicted that the opening of the door 21 performed after the predetermined time period (for example, 10 minutes) has elapsed from the previous closing of the door 21 is for a purpose of entering the vehicle. For example, there may be a high possibility that turning on of the interior light 11 for driving preparation upon entering the vehicle is necessary. Accordingly, the lighting time period of the interior light 11 after the door 21 is closed is not shortened to ensure driver's visibility in the vehicle interior.

When the door 21 is opened after the timer 105 has exceeded the predetermined time period (step A09: YES), the lighting ECU 10 may refrain from resetting the timer 105 after the door 21 is closed (step A13: YES). For example, once the opening of the door 21 is not detected within the predetermined time period (for example, 10 minutes) from when the door 21 is closed, the lighting time period of the interior light 11 after the door 21 is closed may not be shortened in the opening and closing of the door 21 to be performed thereafter. This makes it possible to prevent degradation of visibility for driving preparation when, for example, any of the doors 21 is opened and closed to load any item such as baggage into the vehicle 2 and thereafter another door 21 is opened and closed within the predetermined time period to enter the vehicle 2.

When it is determined in step A01 that the ignition 31 is ON (step A01: NO), the lighting ECU 10 may delete the stored opening data of the door 21 and the data regarding a measured time period of the timer 105 being operated (step A15). When the opening data of the door 21 and the data regarding the measured time period of the timer 105 being operated are not stored, the lighting ECU 10 may skip the process of step A15. When opening of the door 21 is detected while the ignition 31 is in the ON state (step A16: YES), the lighting ECU 10 may turn on the interior light 11 (step A17). Thereafter, when closing of the door 21 is detected (step A18: YES), the lighting ECU 10 may cause the interior light 11 to be turned off when the first time period has elapsed after the closing of the door 21 is detected (step A19) and end the series of processes.

When switching ON of the ignition 31 is detected, the lighting ECU 10 may delete the opening data of the door 21 and the data regarding the measured time period of the timer 105 being operated. The opening data of the door 21 may therefore not be stored when the door 21 is opened for the first time after the ignition 31 is switched OFF. When the opening data of the door 21 is not stored, the determination of step A04 is YES, and the lighting ECU 10 may cause the process to proceed to step A05. This makes it possible to cause the interior light 11 to be turned off when the second time period has elapsed after the door 21 is closed, in a case where the door 21 is opened and closed for the first time after the ignition 31 is switched OFF, and to reduce the power consumption of the battery 41.

By executing the control described above, when there is a high possibility that the door 21 is opened and closed for a reason other than for entering the vehicle, such as when the door 21 is opened and closed multiple times within the predetermined time period, it is possible to shorten the lighting time period of the interior light 11 after the door 21 is closed. This helps to reduce the power consumption of the battery 41 due to unnecessary lighting of the interior light 11.

In the example embodiment, the predetermined time period of the timer 105 may be set to 10 minutes. In some embodiments, the predetermined time period may be a time period other than 10 minutes. In some embodiments, the predetermined time period may be 5 minutes that is shorter than 10 minutes. In some embodiments, the predetermined time period may be a time period of about 20 minutes that is not excessively long.

Next, a description is given of an interior light control system 1A according to a modification example of the interior light control system 1 according to the example embodiment. In the interior light control system 1A of the modification example, descriptions for parts that overlap with the interior light control system 1 will be omitted. The configuration of the interior light control system 1A is similar to that of the interior light control system 1 illustrated in FIG. 1, and therefore descriptions for the EUCs and the control target devices will be omitted.

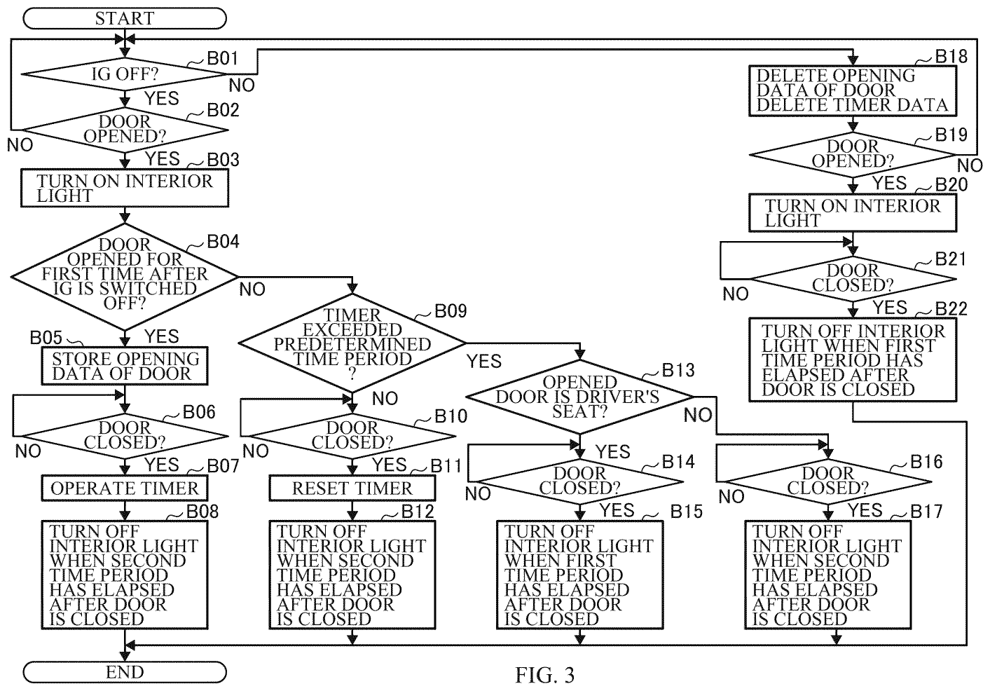

A description will now be given of a control flow of the lighting ECU 10 of the interior light control system 1A according to the modification example with reference to FIG. 3. The control illustrated in FIG. 3 may be executed when the interior light switch 12 is set to the “AUTO (DOOR)” state similarly to the interior light control system 1.

The processes of step B01 to step B12 illustrated in FIG. 3 are similar to the processes of step A01 to step A12 illustrated in FIG. 2, the processes of step B18 to step B22 illustrated in FIG. 3 are similar to the processes of step A15 to step A19 illustrated in FIG. 2, and therefore, the descriptions thereof are omitted.

In the interior light control system 1A, when it is determined in step B09 by the lighting ECU 10 that the timer 105 has exceeded the predetermined time period when the door 21 is opened (step B09: YES), the lighting ECU 10 may determine whether the door 21 that has been opened corresponds to the driver's seat (step B13). When a signal from the door opening and closing switch 211 is received, and the opening of the door 21 is detected, the door ECU 20 may output, to the in-vehicle network 4, data regarding the opening and closing of the door 21 including data regarding to which seat of the vehicle 2 the opened door 21 corresponds. The lighting ECU 10 may determine whether the door 21 that has been opened corresponds to the driver's seat, based on the data acquired from the door ECU 20 via the in-vehicle network 4. When it is determined that the door 21 that has been opened corresponds to the driver's seat (step B13: YES), the lighting ECU 10 may cause the process to proceed to step B14. When it is determined that the door 21 that has been opened does not correspond to the driver's seat (step B13: NO), the lighting ECU 10 may cause the process to proceed to step B16.

In step B13, when it is determined that the door 21 that has been opened corresponds to the driver's seat (step B13: YES), the lighting ECU 10 may monitor closing of the door 21 (step B14). When detecting the closing of the door 21 (step B14: YES), the lighting ECU 10 may turn off the interior light 11 when the first time period has elapsed after the door 21 is closed (step B15) and end the series of processes.

In contrast, in step B13, when it is determined that the door 21 that has been opened does not correspond to the driver's seat (step B13: NO), the lighting ECU 10 may monitor closing of the door 21 (step B16). When detecting that the door 21 is closed (step B16: YES), the lighting ECU 10 may cause the interior light 11 to be turned off when the second time period has elapsed after the door 21 is closed (step B17) and end the series of processes.

As described above, in the interior light control system 1A, even when the door 21 is opened after the predetermined time period has elapsed from the previous closing of the door 21, the lighting time period of the interior light 11 after the door 21 is closed may be shortened, when the door 21 that has been opened does not correspond to the driver's seat. With such a control, even when the predetermined time has elapsed, the lighting time period of the interior light 11 after the door 21 is closed may be shortened in a case where turning on of the interior light 11 for driving preparation upon entering the vehicle is unnecessary. This helps to reduce the power consumption of the battery 41.

Further, in the interior light control system 1A, even when it is determined, in step B13, that the door 21 that has been opened does not correspond to the driver's seat (step B13: NO), and the interior light 11 is to be turned off when the second time period has elapsed after the door 21 is closed (step B17), the timer 105 may not be reset. This helps to prevent shortening the lighting time period of the interior light 11 and degrading the driver's visibility in a case where, for example, at the time of entering the vehicle 2, the door other than that corresponding to the driver's seat (for example, a door corresponding to a rear seat) is opened to load any item such as baggage into the vehicle 2, and thereafter the door 21 corresponding to the driver's seat is opened and closed to enter the vehicle and perform driving preparation.

Further, in the example embodiment, the lighting ECU 10 may acquire data from other ECU via the in-vehicle network 4 and execute the control of the interior light control system. In some embodiments, components including, for example but not limited to, the door opening and closing switch 211, the IG switch 32, and the battery 41 may be coupled to the lighting ECU 10 by a respective harness. In this case, the lighting ECU 10 may directly acquire a signal related to the operation of each of the door opening and closing switch 211, the IG switch 32, and the battery 41 and execute a control of the interior light control system.

According to the interior light control system of at least one example embodiment of the disclosure, it is possible to reduce the power consumption of the battery due to lighting of the interior light when there is a high possibility that the door is opened and closed for a reason other than for entering the vehicle, such as a case where the door is opened and closed multiple times in a short time.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The CPU 101 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the CPU 101. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the CPU 101 illustrated in FIG. 1.

1. An interior light control system configured to be applied to a vehicle, the interior light control system comprising:
an interior light configured to light an interior of the vehicle; and
a processor configured to control turning on and off of the interior light, based on opening and closing of a door of the vehicle, wherein
the processor is configured to:
when the door is opened, turn on the interior light;
when the door is closed, turn off the interior light after a first time period has elapsed; and,
when the door is closed where the door is opened before a predetermined time period elapses after previous closing of the door with ignition of the vehicle being turned off, turn off the interior light after a second time period has elapsed, the second time period being shorter than the first time period.

2. The interior light control system according to claim 1, wherein the processor is configured to, when the door is closed where the door is opened and closed for a first time after ignition of the vehicle is turned off, turn off the interior light after the second time period has elapsed.

3. The interior light control system according to claim 1, wherein the processor is configured to
when the door is opened after the predetermined time period has elapsed after previous closing of the door, determine whether the door that has been opened corresponds to a driver's seat of the vehicle, and,
when: the door is opened after the predetermined time period has elapsed after previous closing of the door; and the door is closed where the door is determined not to correspond to the driver's seat, turn off the interior light after the second time period has elapsed.

4. The interior light control system according to claim 2, wherein the processor is configured to
when the door is opened after the predetermined time period has elapsed after previous closing of the door, determine whether the door that has been opened corresponds to a driver's seat of the vehicle, and,
when: the door is opened after the predetermined time period has elapsed after previous closing of the door; and the door is closed where the door is determined not to correspond to the driver's seat, turn off the interior light after the second time period has elapsed.

5. A vehicle comprising:
an interior light control system configured to be applied to the vehicle, the interior light control system including:
an interior light configured to light an interior of the vehicle; and
a processor configured to control turning on and off of the interior light, based on opening and closing of a door of the vehicle, wherein
the processor is configured to:
when the door is opened, turn on the interior light;
when the door is closed, turn off the interior light after a first time period has elapsed; and,
when the door is closed where the door is opened before a predetermined time period elapses after previous closing of the door with ignition of the vehicle being stopped, turn off the interior light after a second time period has elapsed, the second time period being shorter than the first time period.

6. A method of controlling an interior light system of a vehicle including an interior light configured to light an interior of the vehicle, the light being configured to be turned on and off based on opening and closing of a door of the vehicle; the method comprising:
turning on the interior light when the door is opened;
turning off the interior light after a first time period has elapsed when the door is closed, and
turning off the interior light after a second time period has elapsed when the door is closed where the door is opened before a predetermined time period elapses after previous closing of the door with ignition of the vehicle being stopped, the second time period being shorter than the first time period.
